(19) United States
(12) Patent Application Publication
(10) Pub. No.: US 2005/0102284 A1
(43) Pub. Date: May 12, 2005

(54) Dynamic graphical user interface and query logic SQL generator used for developing Web-based database applications

(76) Inventors: Chandramouli Srinivasan, Gresham, OR (US); Balaji Ganesan, Fairview, OR (US); Ekambaram Balaji, Portland, OR (US)

Correspondence Address: Sandeep Jaggi;LSI Logic Corporation, Intellectual Property Law Dept., 1621 Barber Lane, M/S D-106, Milpitas, CA, 95035, US

(21) Appl. No.: 10/705,545

(22) Filed: Nov. 10, 2003

(51) Int. Cl. G06F 17/30

(52) U.S. Cl. 707/4

(57) ABSTRACT

A method and system for dynamically generating database queries is disclosed. The method and system include storing web interface data, including query attributes for a database, in one more tables. The attributes are then retrieved from the tables and displayed in a graphical user interface web page for user selection. Based on the attributes selected by the user, a SQL query is dynamically generated. The method and system further include displaying results of the SQL query to the user in graphical format, thereby enabling dynamic generation of custom queries.

### FIELD OF THE INVENTION

The present invention relates to web interface generation and techniques of query implementation, and more particularly to a dynamic graphical user interface and query logic SQL generator used for developing Web-based database applications.

### BACKGROUND OF THE INVENTION

Building easy to use and dynamic database user interfaces is one of the major challenges for any web application development project. The backend implementation of business logic that supports any user interface needs to be very generic in order to efficiently manage; large types of data, attributes, information and variations of the queries. In addition, the interface needs to be extensible and scalable as the application evolves over time. For any medium to large-scale web application, this is a daunting development task as several constraints come into play in designing such an implementation that meets above-mentioned requirements.

There are inherent problems with traditional approaches for implementing database query Web interfaces. Traditionally, most web-based user interface forms are built one-by-one using a web page design tool, such as Microsoft FrontPage™, Macromedia ColdFusion MX™, or by manually writing HTML code. This process is very time consuming and impractical for a rich user interface. Any rich database, such an integrated circuit design statistics database, for example, has numerous attributes. In general, a database designer creates queries that are classified into logic groups based on the sets of attributes that are queried. In the traditional approach, a separate web page would be manually created for each functional grouping of queries for display and selection by a user who wishes to query the database. This has the disadvantage of requiring re-work every time a new functional group of queries are created.

A related problem occurs when a user of the database is interested in querying a new combination of design attributes. The traditional approach is to separately implement the query statement needed to execute each query. For a large complex database with countless possible attribute, and query combinations, it may be impractical to implement each query manually. This problem becomes even more daunting as the number of database attributes grows.

Finally, a key aspect of any query is the presentation of the results of the query. With varied design attributes and types of aggregate operations that can be performed on these design attributes (sum, count, percentage, average, maximum, minimum, top ten, etc.), the display of the results in a manner that is most suited for each query is key. Traditional approaches are limited in this regard.

A major issue in using traditional approaches for GUI building and query writing is maintenance. As the application may evolve very quickly over time, the application needs to be constantly updated for new requirements. As the number of records in the database grows and the number of attributes available for querying grows, it becomes necessary to allow the user to perform complex trend analysis and finely control the set of attributes on which the queries operate. Traditional approaches do not provide this level of granularity without tremendous maintenance costs.

One possible improvement to the traditional approach is to use more sophisticated server-side scripting tools to generate GUI database forms. However, even with server side scripting tools, the GUI forms are explicit pieces of code that are individually created based on requirements of each web page comprising the user interface. What this means is every time a change is made, the changes must be made manually and in several places, resulting in a tedious update process. This significantly impacts the maintenance on that application.

Accordingly, what is needed is a method for building a web-based query interface that is very low maintenance and as easy to update. Users should be able to create custom database queries in real-time without high maintenance costs. The present invention addresses such a need.

### SUMMARY OF THE INVENTION

The present invention provides a method and system for dynamically generating database queries. The method and system include storing web interface data, including query attributes for a database, in one or more tables. The attributes are then retrieved from the tables and displayed in a graphical user interface web page for user selection. Based on the attributes selected by the user, a SQL query is dynamically generated. The method and system further include displaying results of the SQL query to the user in graphical format, thereby enabling dynamic generation of custom queries.

According to the method and system disclosed herein, storing attributes in tables provides the system with the ability to handle the addition of new functional logical attribute categories, and queries by simply updating tables. This facilitates extensibility of the system with minimal investment. And by displaying the attributes and allowing the user to select any combination of attributes and values on GUI, the present invention enables user to create customized queries, that are generated and executed dynamically. This significantly reduces maintenance costs because a database administrator does not have to manually write queries for the database for each new user request.

### BRIEF DESCRIPTION OF THE DRAWINGS

FIG. 1 is a block diagram illustrating a dynamic query generator system in accordance with a preferred embodiment of the invention.

FIG. 2 is a flowchart illustrating the process for dynamically generating a web-based GUI for querying a database according to a preferred embodiment of the present invention.

FIG. 3 is a diagram illustrating an exemplary structure of the two page builder tables. The names and functions of the table are described below.

FIG. 4 is a diagram illustrating an example basic query web page generated by the page builder using the page builder tables.

FIG. 5 is a diagram illustrating an example of the query customization page.

FIG. 6 is a diagram showing a pictorial representation of how the query processor functions.

FIG. 7 is a diagram showing a graph displayed by the presentation logic.

### DETAILED DESCRIPTION OF THE INVENTION

The present invention relates to dynamic generation of web interfaces database querying. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A database is a collection of tables, each storing information on related fields or columns, each of which represents a particular attribute. A table could have one or more rows with each row containing values for the columns/attributes of the table. A query is a mechanism by which a user performs various operations on the database, such as retrieving information or updating data to the tables. In the context of this invention, a query is restricted to a user retrieving data from a database. When the user runs a query, the query is executed and the results are displayed in the format chosen by the user.

The present invention provides a dynamic query generator system that displays a web-based GUI for user input and automatically generates SQL queries from the input for querying a database. For the purposes of example, the present invention will be described in terms of a Statistics Information Management Programs and Lookup Environment (SIMPLE), which is Web-based statistics management tool to support query and analysis of integrated circuit design information data stored in circuit design database. However, the present invention may be used with any type of database data. In a preferred embodiment, the present invention is written in the ColdFusion CFML language.

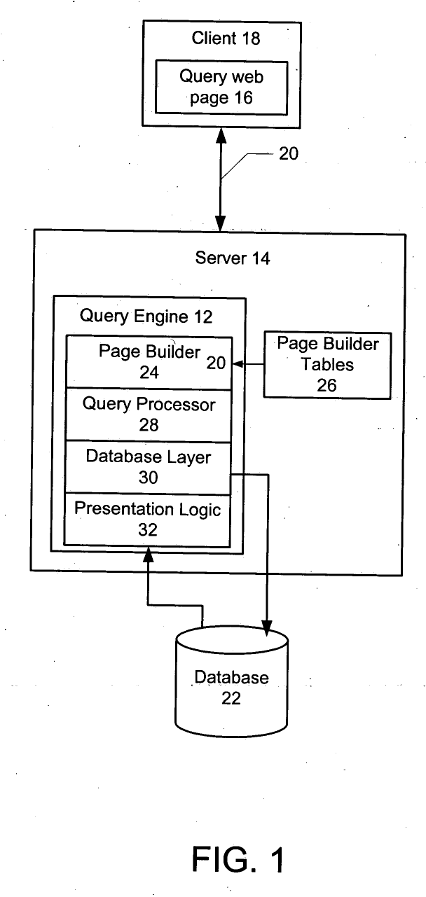

FIG. 1 is a block diagram illustrating a dynamic query generator system in accordance with a preferred embodiment of the invention. The dynamic query generator system 10 of the present invention provides a query engine 12 that functions as a web-based, dynamic graphical user interface (GUI) builder and database query generation engine for a database 22. In a preferred embodiment, the query engine 12 executes on a server 14 that is a communication with client computer 18 over a network 20. Based on a pre-defined structure and organization, the query engine 12 generates and displays GUI query web pages 16 on the client computer 18 for user selection of attributes. As used herein, an attribute is any data stored in a database 22 that is available for querying.

In a preferred embodiment, the query engine 12 includes a page builder 24, page builder tables 26, a query processor 28, a database layer 30, and presentation logic 32. The page builder tables 26 store web interface data, which includes attributes pertaining to the data in the database 22. The page builder 24 displays the query web pages 16 by accessing the web interface data from the page builder tables 26. After the query web pages 18 are displayed to a user for selection of attributes (and their values), the query processor 28 generates SQL statements based on the attributes chosen by the user. The database layer 30 comprises the SQL queries that are generated by the query processor 28 to retrieve information from the 22 database. The presentation logic 32, which implements a charting engine, displays the results of the executed SQL query to the user in graphical format.

Storing web interface data and attributes in the page builder tables 26 provides the query processor 28 with the ability to handle the addition of new functional logical categories and attributes, and queries by simply updating the page builder tables 24. This facilitates extensibility of the query processor 28 application 12 with minimal investment. And by displaying the attributes and allowing the user to select any combination of attributes and values on GUI, the present invention enables user to create customized queries, which are generated and executed dynamically (i.e., in real-time). This significantly reduces maintenance costs because a database administrator does not have to manually write queries for the database 22 for each new user request.

As stated above, the results of each executed query are displayed graphically, such as in a graph or table, which include an X-axis and Y-axis. According to the present invention, the web interface data is presented on the web pages 16 such that a user may select which attribute(s) is plotted along the X-axis of the graph, referred to herein as an X attribute, and which attribute(s) is plotted along the Y-axis of the graph, referred to herein as a Y attribute.

In addition, the user may select a series attribute, and/or a filter attribute. A series attribute refers to an attribute that is used to distinguish values plotted on the Y-axis in reference to each X-axis data point. In particular, a series attribute represents the query parameter that is used to group Y-axis data by. A filter is a group of attributes that are used to restrict the scope of a query. By selecting a group of attributes (and their values) and saving them, the user can apply this filter to any query that is executed. The query would return on those records that match the filter chosen.

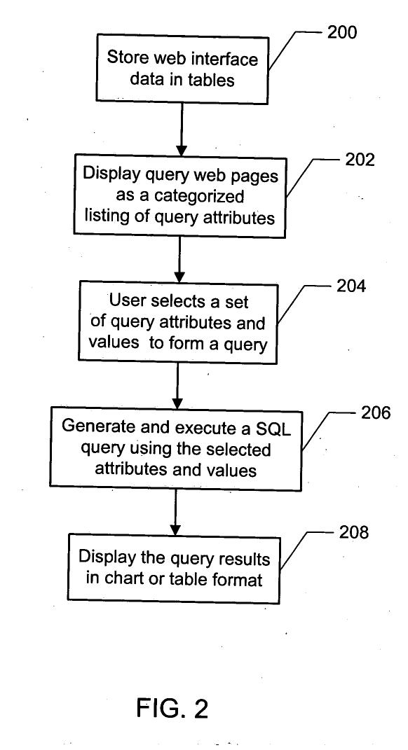

FIG. 2 is a flowchart illustrating the process for dynamically generating a web-based GUI for querying a database according to a preferred embodiment of the present invention. The process begins in step 200 by storing the web interface data, including query attributes, into the page builder tables 26.

In a preferred embodiment, the web interface information is stored in three page builder tables: QRY_PAGE_DATA, QRY_ATTRIBUTES, and a LOOKUP_PROCESS_FACTOR table, although any number of tables may be used.

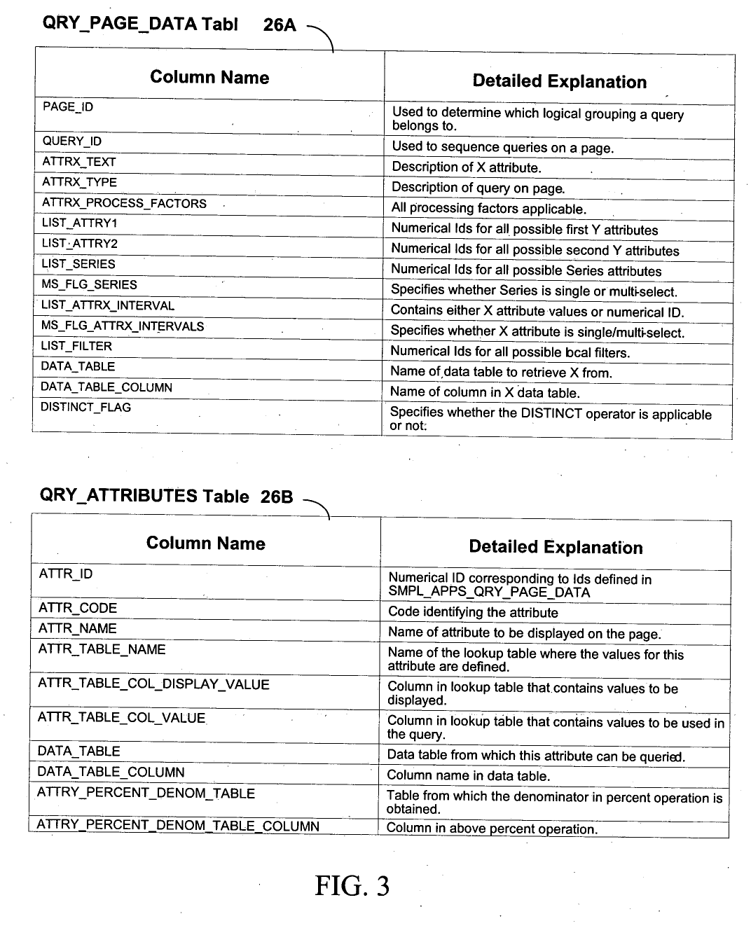

FIG. 3 is a diagram illustrating an exemplary structure of the page builder tables 26A and 26B. The names and functions of the table are described below. The QRY_PAGE DATA table 26A includes the following columns/fields: The PAGE_ID is used to determine which logical grouping a query belongs to. The QUERY_ID is used to sequence queries on a page. The ATTRX_TEXT is used to store a description of X attribute. The ATTRX_TYPE description of query on page. The ATTRX_PROCESS_FACTORS is used to store processing factors applicable to an attribute. The LIST_ATTRY1 stores numerical Ids for all possible first Y attribute. The LIST_ATTRY2 stores numerical ID for all possible second Y attributes. The LIST_SERIES stores numerical IDS for all possible Series attributes. The MS_FLG_SERIES specifies whether Series is single or multi-select. The LIST_ATTRX_INTERVAL contains either an X attribute value or a numerical ID. The MS_FLG_ATTRX_INTERVALS specifies whether the X attribute is single/multi-select. The LIST_FILTER stores numerical IDS for all possible local filters. The DATA_TABLE stores the name of database table from which to retrieve X from. The DATA_TABLE_COLUMN stores the name of column in X data table. The DISTINCT_FLAG specifies whether the DISTINCT operator is applicable or not.

The QRY_ATTRIBUTES table 26B includes the following columns/fields: The ATTR_ID stores a numerical ID corresponding to IDS defined in QRY_PAGE_DATA table 26A. The ATTR_CODE Code identifies the attribute ATTR_NAME Name of attribute to be displayed “on the page. The ATTR_TABLE_NAME stores a name of the lookup table where the values for this attribute are defined. The ATTR_TABLE_COL_DISPLAY_VALUE identifies a column in the lookup table that contains values to be displayed. The ATTR_TABLE_COL_VALUE identifies a column in the lookup table that contains values to be used in the query. The DATA_TABLE Data table from which this attribute can be queried. The DATA_TABLE_COLUMN Column name in data table. The ATTRY_PERCENT_DENOM_TABLE is a table from which the denominator in percent operation is obtained. The ATTRY_PERCENT_DENOM_TABLE_COLUMN is a column used in above percent operation.

Referring again to FIG. 2, in step 202, in response to a user navigating to the query engine 12 site, the query web pages 16 are displayed as a functionally categorized listing of query attributes. In step 204, the user selects a set of query attributes and values, which will be used to form a query. In a preferred embodiment, a minimum amount of information is required to generate and run a query is the following; at least one X attribute, at least one Y attribute, a process factor to apply to the Y attribute, and a report format indicating the display format of the query results, such as graph, chart, or table.

In a preferred embodiment, the user has an option to form a query from a basic query page or a query customization page. Both query pages are displayed by the page builder 24 by accessing the page builder tables 26.

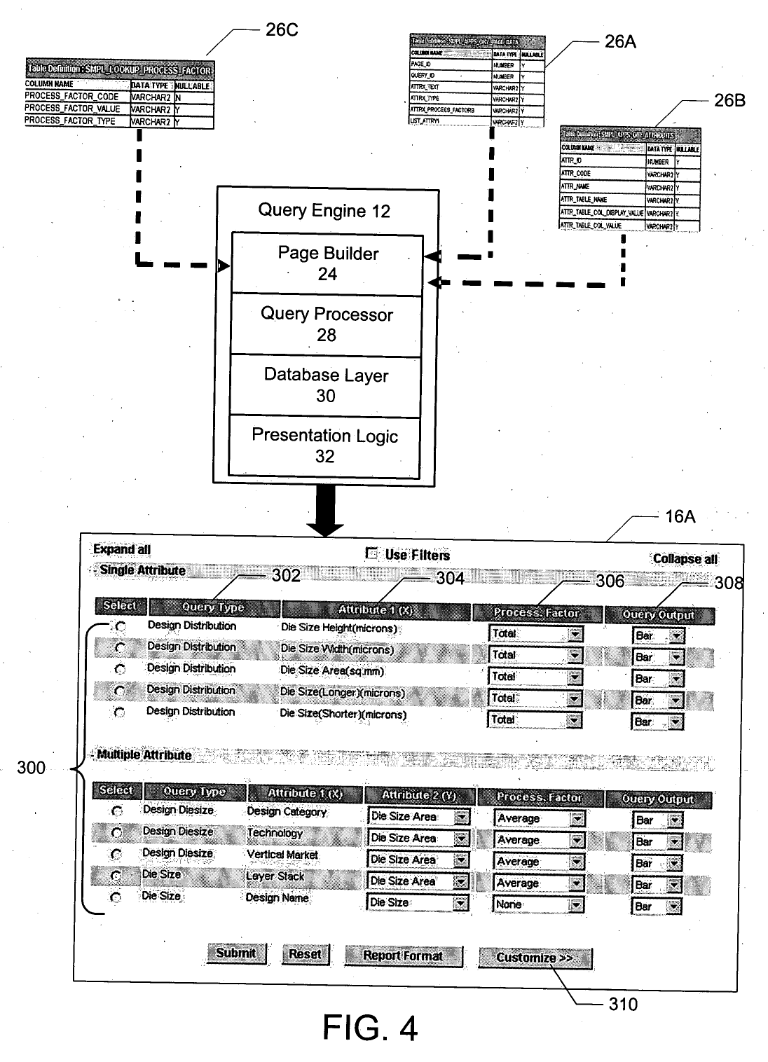

FIG. 4 is a diagram illustrating an example basic” query web page 16A generated by the page builder 24 using the page builder tables 26. The basic query page 16A displays rows of query attributes 300, where each row includes a field for the attribute type 302, an attribute description 304, process factors 306 that are used to calculate values for Y-axis attribute in the form of a drop-down list, and a query output drop-down list 308 that allows the user to choose the graphical format of the output, e.g., bar graph, pie chart, or table.

The basic query page 16A also displays a “Customize” link 310 that leads to the query customization page. If the user chooses to run a query by selecting query attributes from the basic query page 16A, the query will use all possible values for the selected X attributes in creating the query. If the user wishes to restrict the X-axis to certain values or customize the query in any fashion, the user should use the query customization page to do so.

Queries may be formed as single attribute queries or multiple attribute queries, as shown on the basic query page 16A. A single attribute query only includes X attributes. In a single attribute query, the selected X attribute(s) is displayed in the output as a distribution using the selecting process factor 306. For example, assume that the user selects “Die Size” as the single attribute and “Total” as the process factor. Here, “Die Size” is the X attribute and “Total” is the process factor, and the total number of designs corresponding to each die size is the Y attribute.

In a multiple attribute query, the user may explicitly choose X and Y attributes. The distinction between a single attribute and multiple attribute query is that in a multiple attribute query, there are two explicit attributes that are queried (one each for the X and Y axis), whereas in a single attribute query, the Y axis value is a distribution of some kind.

The page builder 24 uses the values present in the columns of the QRY_PAGE_DATA table 26A and the LOOKUP_PROCESS_FACTORS table 26C to build the basic query page 16A. Referring to FIGS. 3 and 4, the page ID determines which query web page 16 a particular functional group of query attributes is displayed in. In a preferred embodiment, the basic query page 16A displays a series of links to other query web pages, each associated with a different page ID. When the user navigates to a query web page 16 identified by a given Page_ID, the page builder 24 retrieves the records in the QRY_PAGE_DATA table having that Page_ID and displays them as the query attribute rows.

Each row of query attributes displayed on the basic web page 16A is identified by a unique Query ID. The query type on the basic query page 16A for each query attribute is populated from the Attribute_Type field. The name of the attribute is populated from the Attribute_Text field. The Process Factor drop-down list is populated by using the Attribute_Process_Factors field as an index to the LOOKUP_PROCESS_FACTORS table 26C to retrieve the corresponding record. The process factors are all possible aggregate operations that can be performed on the Y attributes.

Other column entries in the QRY_PAGE_DATA are in the form of IDs (numbers), which refer to entries in the QRY_ATTRIBUTES table. The usage of such IDs is explained with respect to the query customization page 16B. Examples of entries that contain IDs instead of values are Series attributes and Filter attributes.

Once the basic query web page 16A is displayed, the user chooses a set of query attributes on which to query the database by clicking the “Select” button in each desired row. When done, the user clicks the “Submit” button. If the user chooses to form the query using the advanced query web page, rather than the basic query page 16A, then user clicks the “Customize” link 310 to navigate to the query customization page.

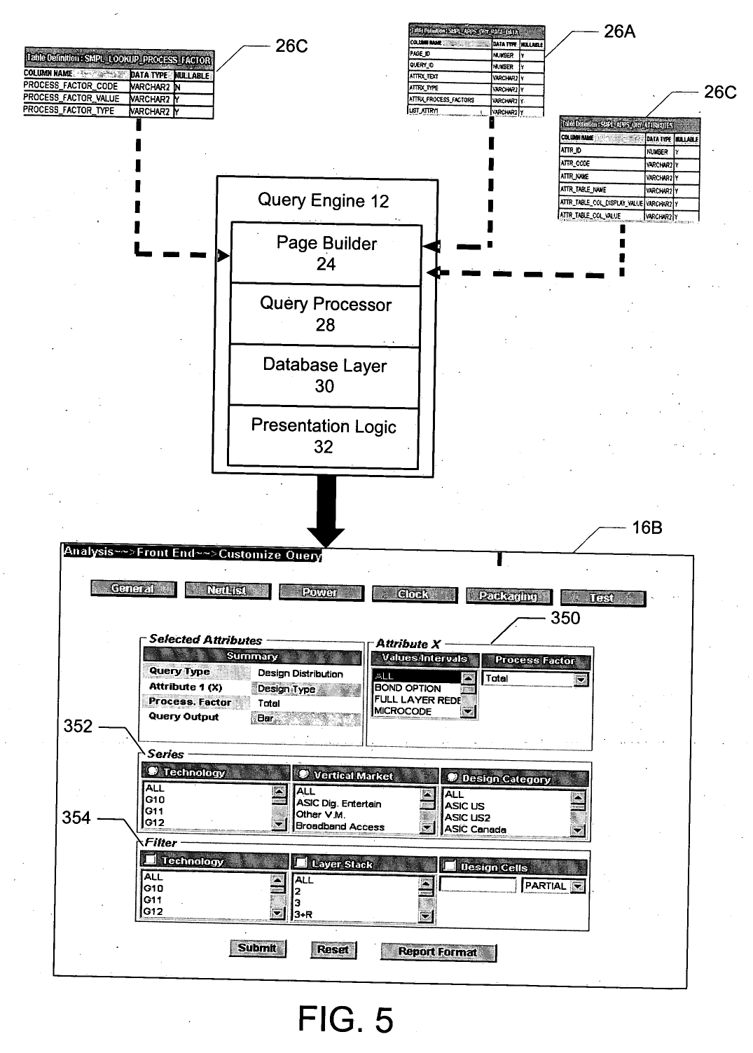

FIG. 5 is a diagram illustrating an example of the query customization page. The page builder 24 utilizes values from the QRY_ATTRIBUTES table 26B to create the display values for the query customization page 16B. Referring to both FIGS. 3 and 5, certain values in the QRY_PAGE_DATA table 26A are represented as IDs, instead of actual values. One of these ID's is the Attribute ID. The Attribute ID represents a design attribute in the QRY_PAGE_DATA table 26A and is the primary key of the QRY_ATTRIBUTES table 26B. The Attribute_Name and Attribute_Code fields in the QRY_ATTRIBUTES table 26B store the display name of and code of the attribute. In addition, ATTR_TABLE_NAME and ATTR_TABLE_COL_DISPLAY_VALUE provide the table name and column name of the lookup table in which the values corresponding to this attribute are defined. The query processor 28 uses this table name and column name to retrieve the actual value's that are to be used for display on the query customization page. The following are the main components of the query customization page 16B and the table name/column name from which they are retrieved.

The X Attribute 350, shown as “Attribute X,” is the list of X-axis values that are used in the query. These can be present as actual values in the QRY_PAGE_DATA 26A table, or they can be represented through an ID in the QRY_ATTRIBUTES table 26B. If the X Attribute is represented as an ID, the actual values may be retrieved from a lookup table by the page-builder 24.

The “Series” attribute 352 is the query parameter that is used to group the Y-axis data by. Every series attribute 352 in a particular query is represented through its attribute ID. The page builder 24 retrieves the series corresponding to each attribute ID from the QRY_ATTRIBUTES table 26B. The values corresponding to each series attribute is retrieved from its lookup table.

The user may also choose to restrict the database record set on which the query processor 28 operates, by specifying “Filter” attributes 354. The filter attributes 356 on a particular customization page are populated in the same manner as the series attribute. By choosing a local filter, the user tells the query processor 28 to restrict the search to only those database records that match the selected local filter criteria. For example, in the example customized query page 16B, the user can choose a local filter “Technology” as “G12”. This would restrict the search to those designs in the design database that belong to the G12 technology family.

Referring again to FIG. 2, in response to the user choosing a set of attributes from the query web page(s) 16 and submitting the query as described above, in step 206, the query processor 28 generates a SQL query using the selected attributes and values and executes the SQL query.

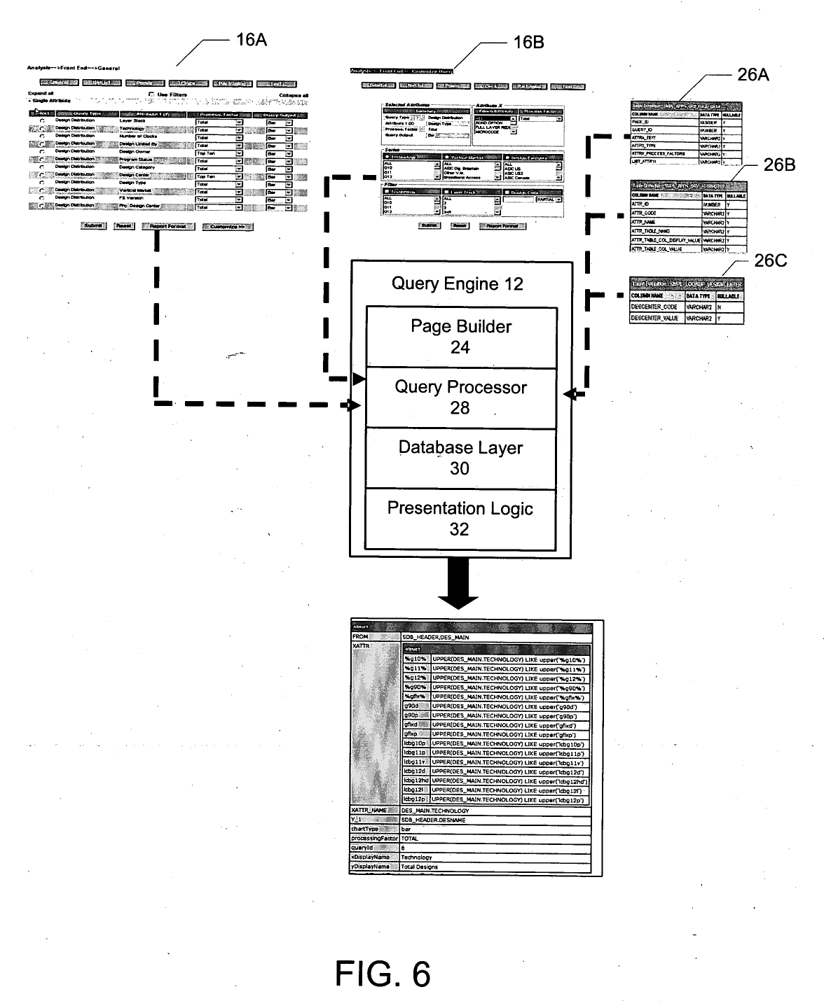

FIG. 6 is a diagram showing a pictorial representation of the query processor flow. The query processor 28 is the component of the query processor 28 that processes the user's selection. When the user submits a query by clicking on the “Submit” button, inputs to the query processor 28 from the query web page is 16 and page builder table 26 are provided in the form of ColdFusion form variables. The query processor 28 iterates through the form variables and constructs a ColdFusion structure that is used to generate a dynamic SQL SELECT statement. As is well-known in the art, a SQL statement comprises three main clauses, SELECT, FROM, and WHERE. The syntax of the SELECT statement is in the form of:

SELECT [list of table columns]
FROM [list of table names],
WHERE [condition on one or more table columns]

Some of the entries on the query page 16 (for example, the Y attribute) are always passed into the query processor 28 because they have default values defined for them. Certain others, such as the Series attribute, are passed in only if the user explicitly chooses them. Each query has a default processing factor. The user has the option of choosing a different processing factor.

There are three main components of the SQL query that need to be inserted into the SQL SELECT statement; the table and column names for the various attributes, the X attribute value/interval set, and the series value/interval set. In order to determine the table/column names, the query processor 28 accesses the QRY_ATTRIBUTES table 26B that contains the table and column names of the X, Y and. Series (if present) attributes. Through this mechanism, it also determines the table names for the “FROM” clause.

Next, the query processor 28 constructs the X attribute and Series attribute values. If the user ran the query from the basic query page 16A, the entire X value/interval set is used in the query. If the user ran the query from the query customization page 16B, he or she can choose a subset of X values and/or series values 352 to base the query upon. These values are inserted into the “WHERE” clause in the SQL statement.

The processing factor is applied to the values of the Y attribute, usually in the form of a SQL aggregate operation (such as average, sum or count). The processing factor could be directly available as a database function or could be implemented by the query processor 28 (example, percentage operation).

Once the ColdFusion structure is created and populated, the query processor 28 loops through the elements in the structure to construct the final SQL statement to be generated. There are as many SELECT statements (joined together by a UNION statement) created as there are X attribute values (if the X attribute is a range or if neither X or the Series is a range) or Series attribute values (if the Series attribute is a range).

The SELECT statement is constructed to always return a record-set that contains three columns: the X attribute, the Y attribute and the Series attribute (if chosen). Once the final SQL statement has been constructed, it is executed through a “CFQUERY” statement. The query processor 28 then iterates through the record-set (not shown) that is returned by the database 22. The query processor 28 creates another ColdFusion structure that stores the record-set in a manner conducive to displaying as a graph. In addition, the query processor 28 creates a ColdFusion structure that contains the graph attributes that the user-chose.

Referring again to FIG. 2 after the results are returned, in step 208 the query engine 12 invokes the presentation logic 32 to display the query results in graphical form. The data that is returned from the database 22 is transferred to the presentation logic 32 through a ColdFusion structure. The presentation logic 32 processes the data structure and the attribute structure created by the query processor 28 and displays a chart or graph in the manner that the user requested. The user can configure various display parameters such as the chart title, x-axis title, y-axis title, width/height of the chart, representation of the series, and so on by clicking on the “Report Format” button on the query web pages 16. If the user does not provide any inputs on the type of display, the presentation logic 32 displays default values for each display attribute.

In addition, the presentation logic 32 contains the intelligence to create meaningful intervals for the y-axis display. For example, if the y-axis values that are plotted contain floating point numbers, the presentation logic 32 determines a meaningful range (maximum and minimum value to be plotted), the interval (each individual value on the y-axis) so that the values on the y-axis are integers. Similar functionality exists for display of percentage values also.

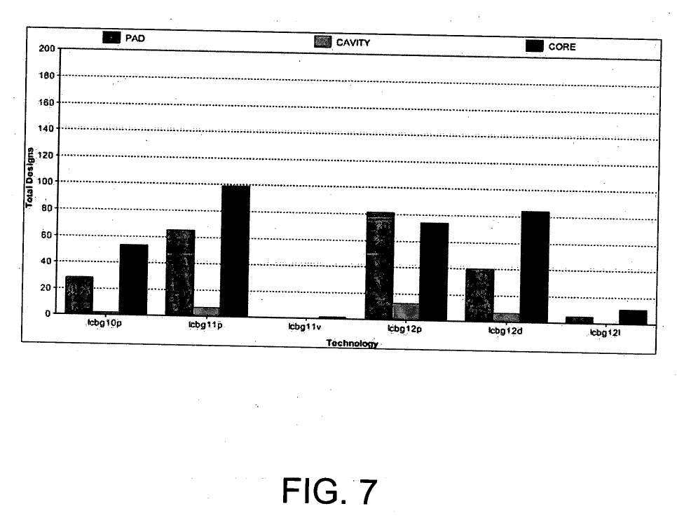

FIG. 7 is a diagram showing a graph displayed by the presentation logic 32. The X attributes rows and values are displayed along the x-axis of the graph, while the Y attribute values are formed along the Y-axis of the graph. Each X attribute is grouped by a series attribute, the caption for which is displayed along the top of the graph.

A dynamic graphical user interface and query logic SQL generation system 10 used for developing Web-based database applications has been disclosed. The query processor 28 of the present invention provides a complex processing engine that can support all attributes, construct queries, execute them on the database 22 and return the results in the form tables, charts and graphs. The various components of the query processor 28 provide a modular and structured architecture in which presentation logic is separated from business logic. Advantages of the dynamic query generation system 10 include:
1) easy to maintain, update and add new functionality, such as new queries,
2) generalized query processing logic allows for reuse in other applications,
3) scales automatically when new attributes are added (the benefits of this system 10 are realized as more queries are added to the system),
4) generating SQL query statements dynamically, based on the user's query parameters is a major improvement over the conventional approach of implementing each query manually,
5) generates dynamic charts by utilizing the data retrieved by the query processor 28 and user inputs provided to customize the display of the results,
6) the presentation logic 32 does not need to be updated when new query attributes are added; and
7) is implemented in a layered manner such that the central functionality of the database is separated from the generation of the GUI and query generation, allowing for ease of modification.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

1. A method for dynamically generating database queries, comprising:
(a) storing query web interface data, including attributes for a database, in one more tables;
(b) retrieving the attributes from the table and displaying the attributes on a graphical user interface web page for user selection;
(c) dynamically generating a SQL query based on the attributes selected by the user; and
(d) displaying results of the SQL query to the user in graphical format, thereby enabling dynamic generation of custom queries.

2. The method of claim 1 wherein step (b) further includes the step of: displaying the attributes as a functionally categorized listing of query attributes.

3. The method of claim 2 wherein the graphic format for displaying the results includes an X-axis and Y-axis.

4. The method of claim 3 wherein step (b) further includes the step of: in order to generate the SQL query, requiring at least a first attribute to be plotted along the X-axis, a second attribute to be plotted along the Y-axis, wherein the first attribute comprises an X attributes and the second attribute comprises a Y attribute, and a process factor to apply to the Y attribute.

5. The method of claim 4 wherein step (b) further includes the step of: allowing the user to select a series attribute, wherein the series attribute represents a query parameter that is used to group Y attribute values plotted.

6. The method of claim 5 wherein step (b) further includes the step of: allowing the user to select a filter, wherein the filter is a group of attributes that are used to restrict the scope of a query.

7. The method of claim 2 wherein step (b) further includes the step of: allowing the user to form a query from a basic query page or a query customization page.

8. The method of claim 7 wherein step (b) further includes the step of: displaying on the basic query page rows of attributes, where each row includes a field for an attribute type, an attribute description, and process factors that are used to calculate Y attribute values.

9. The method of claim 7 wherein step (b) further includes the step of: allowing queries to be formed as single attribute queries or multiple attribute queries, wherein a single attribute query only includes an X attribute where a result of a query is displayed as a distribution, and wherein in a multiple attribute query, the user chooses X and Y attributes.

10. The method of claim 1 wherein step (a) further includes the step of: storing the attribute data in at least two attribute tables.

11. The method of claim 10 wherein step (c) further includes the step of: generating the query by inserting into a SQL SELECT statement, table and column names for the selected attributes, an X attribute value set, and a series value set.

12. The method of claim 11 wherein step (c) further includes the step of: retrieving the table and column names for the selected attributes from one or more of the attribute tables.

13. The method of claim 12 wherein step (c) further includes the step of: inserting the X attribute value set, and a series value set into a WHERE clause of the SQL statement.

14. The method of claim 13 wherein step (c) further includes the step of: creating respective SQL SELECT statements joined together by a UNION statement for each of the X attribute values.

15. A dynamic query generator system, comprising
a client computer coupled to a network;
a server coupled to the network in communication with the client computer; and
a query engine executing on the server, the query engine functioning to,
generate and display GUI pages on the client computer for user selection of database attributes,
using the inputs provided by the user to automatically generate a SQL query to retrieve data from a database, and
display results of the query to the user in graphical format, thereby enabling dynamic generation of custom queries.

16. The system of claim 15 wherein the query engine comprises a page builder, page builder tables, a query processor, a database layer, and presentation logic.

17. The system of claim 16 wherein the page builder tables store the attributes.

18. The system of claim 17 wherein the page builder displays the attributes on the GUI pages by accessing the attributes from the page builder tables.

19. The system of claim 18 wherein the query processor generates SQL statements based on the attributes chosen by the user, and the database layer comprises the SQL queries that are generated by the query processor to retrieve information from the database.

20. The system of claim 19 wherein the presentation logic implements a charting engine that displays the results of the executed SQL query to the user in tabular or chart format.
